(19) United States
(12) Patent Application Publication
(10) Pub. No.: US 2026/0036754 A1
(43) Pub. Date: Feb. 5, 2026

(54) OPTICAL-FIBER CONNECTOR

(71) Applicant: ACON OPTICS COMMUNICATIONS INC., New Taipei City (TW)

(72) Inventors: Yang-Yang Cui, New Taipei City (TW); Rui Zhang, New Taipei City (TW)

(21) Appl. No.: 19/288,336

(22) Filed: Aug. 1, 2025

Related U.S. Application Data
(60) Provisional application No. 63/678,260, filed on Aug. 1, 2024.

(51) Int. Cl. G02B 6/38

(52) U.S. Cl. CPC G02B 6/3817; G02B 6/3858; G02B 6/3881

(57) ABSTRACT

An optical-fiber connector includes a first housing, a core component, a conductive module, a second housing, and a sleeve member. The first housing includes a stopping member, a through hole, and a channel. The stopping member is on an outer surface of one of two sides of the first housing, the through hole and the channel are respectively defined through two ends of the first housing, and the channel is at one side of the through hole and corresponds to the other side of the first housing. The core component is elastically displaceably inserted into the through hole of the first housing along a first direction. The conductive module includes two conductive terminals inserted into the channel of the first housing. The second housing is assembled at the through hole at one end of the first housing. The sleeve member is assembled on the second housing.

### CROSS-REFERENCE TO RELATED APPLICATION

This application claims the benefit of U.S. provisional application Ser. No. 63/678,260, filed on Aug. 1, 2024, the entire contents of which are hereby incorporated by reference.

### FIELD OF THE INVENTION

The instant disclosure relates to a connector, and more particular to a connector capable of transmitting optical signals and electric power at the same time.

### BACKGROUND

Electronic devices are widely utilized in various fields. In general, an electronic device may be connected to the power supply through a connector to obtain the electricity for operation. As the electronic device offers increasingly diverse functions, the electronic device may possess requirements for transmitting other types of signals, for example, optical signals. However, under such configuration, to achieve transmission of different types of signals, another connector for transmitting that type of signals has to be used. As a result, the physical layout of the electronic device becomes complicated, resulting in inconvenience for the operation of the electronic device.

### SUMMARY OF THE INVENTION

In view of these, an embodiment of the instant disclosure provides an optical-fiber connector. The optical-fiber connector comprises a first housing, a core component, a conductive module, a second housing, and a sleeve member. The first housing comprises a stopping member, a through hole, and a channel. The stopping member is on an outer surface of one of two sides of the first housing, the through hole and the channel are respectively defined through two ends of the first housing, and the channel is at one side of the through hole and corresponds to the other side of the first housing. The core component is elastically displaceably inserted into the through hole of the first housing along a first direction. The conductive module comprises two conductive terminals inserted into the channel of the first housing. The second housing is assembled at the through hole at one end of the first housing. The sleeve member is assembled on the second housing. Accordingly, one or some embodiments can provide an optical-fiber connector capable of supplying electric power and transmitting optical signals at the same time.

In some embodiments, the first housing further comprises two blocking walls. The two blocking walls are opposite to each other and arranged on the outer surface of the first housing, and the two blocking walls are respectively at two sides of the stopping member.

In some embodiments, the first housing further has a cut opening defined through the outer surface of the first housing, the second housing further comprises a protruding rib, and the protruding rib of the second housing is accommodated in the cut opening.

In some embodiments, a length of the first housing extends along the first direction, a second direction is perpendicular to the first direction, a central position of the first housing along the second direction has a central axis, a central position of the through hole has a first centerline along the second direction, a central position of the channel has a second centerline along the second direction, and the first centerline and the second centerline are respectively at two sides of the central axis.

In some embodiments, the core component comprises a core member and an elastic member, the elastic member is fitted over the core member, the core member abuts against the first housing, and the second housing abuts against the elastic member.

In some embodiments, the core member comprises an insertion pin, a blocking member, and a connection sleeve. The insertion pin and the connection sleeve are respectively at two opposite sides of the blocking member, and the elastic member is fitted over the connection sleeve. The through hole has a first section, a second section, and a third section sequentially connected to each other, the blocking member, the connection sleeve, and the elastic member are in the third section, and the insertion pin is in the first section and the second section.

In some embodiments, a cross-section of the blocking member and a cross-section of the third section are rectangular.

In some embodiments, the conductive module comprises a fitting member, one face of the fitting member has two first fitting grooves, each of the two conductive terminals is retained in a corresponding one of the two first fitting grooves, and the fitting member is retained in the channel.

In some embodiments, a length of the fitting member and a length of the conductive terminals extend along the first direction. Each of the conductive terminals comprises a first pin portion, a stopping portion, an extension section, and a second pin portion sequentially connected to each other. Each of the first fitting grooves is defined through the fitting member along the first direction, each of the first fitting grooves has a depth along a second direction perpendicular to the first direction, and a height of the stopping portion along the second direction and a height of the second pin portion along the second direction are each greater than the depth.

In some embodiments, the first housing further comprises a protrusion in the channel. The face of the fitting member has a second fitting groove between the two first fitting grooves, and two ends of the second fitting groove are respectively an opening and a stopping surface. The fitting member is fitted over the protrusion through the second fitting groove, and the stopping surface abuts against the protrusion.

In some embodiments, the protrusion has two inclined surfaces, and the two inclined surfaces are symmetrically arranged on different positions of the protrusion along the second direction.

According to one or some embodiments of the instant disclosure, through the configuration that the conductive module is provided in the first housing of the optical-fiber connector, the optical-fiber connector can transmit both optical signals and electric power.

### BRIEF DESCRIPTION OF THE DRAWINGS

The instant disclosure will become more fully understood from the detailed description given herein below for illustration only, and thus not limitative of the instant disclosure, wherein:

FIG. 1 illustrates a perspective view of an optical-fiber connector according to an exemplary embodiment of the instant disclosure;

FIG. 2 illustrates an exploded view of the optical-fiber connector of the exemplary embodiment and a mating optical-fiber adapter;

FIG. 3 illustrates an exploded view of the optical-fiber connector of the exemplary embodiment;

FIG. 4 illustrates an exploded partial view of the optical-fiber connector of the exemplary embodiment;

FIG. 5 illustrates a perspective cross-sectional view along line 5-5 shown in FIG. 1;

FIG. 6 illustrates a cross-sectional view of the embodiment shown in FIG. 2; and

FIG. 7 illustrates an assembled cross-sectional view showing the optical-fiber connector of the exemplary embodiment is coupled to the optical-fiber adapter.

### DETAILED DESCRIPTION

Before the instant disclosure is described in detail in various embodiments, it should be noted that in the following description, the drawings are merely for schematic illustration, which are not necessarily drawn to scale, and not all details are necessarily shown in the drawings.

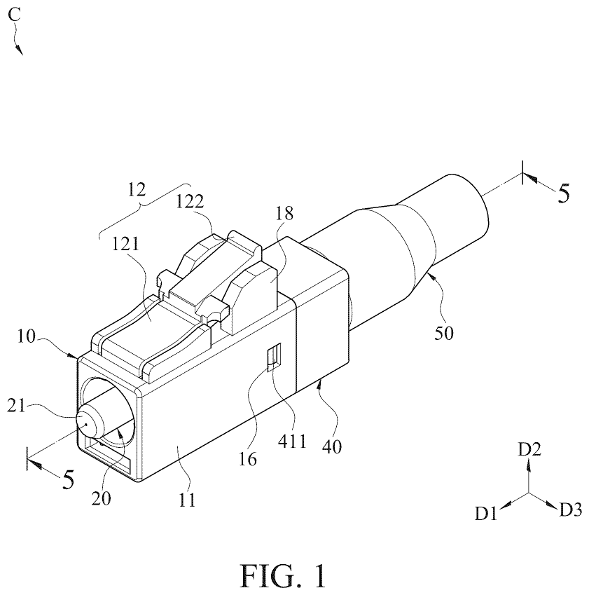

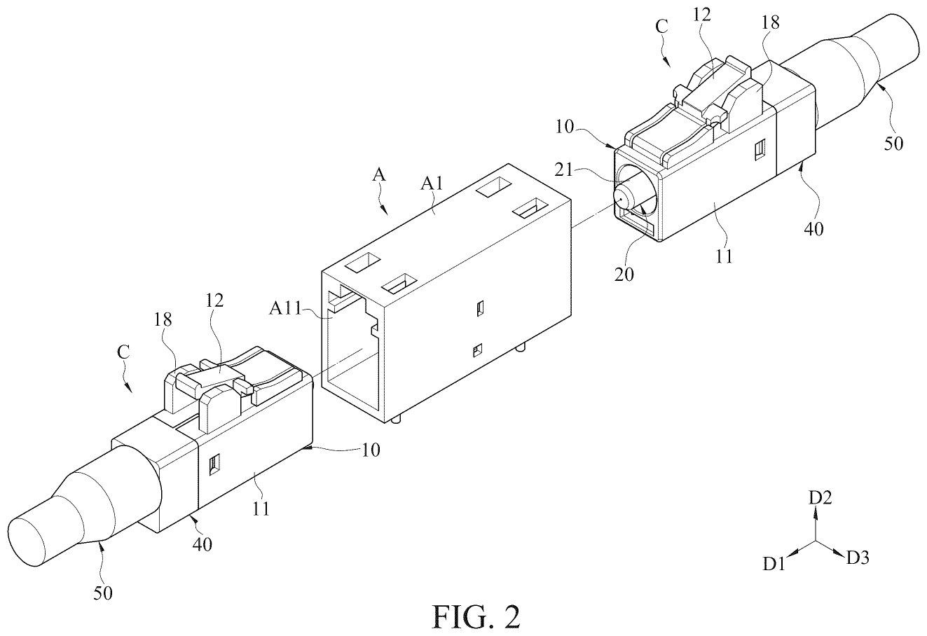

Please refer to FIG. 1 and FIG. 2. FIG. 1 illustrates a perspective view of an optical-fiber connector according to an exemplary embodiment of the instant disclosure. FIG. 2 illustrates an exploded view of the optical-fiber connector of the exemplary embodiment and a mating optical-fiber adapter. In this embodiment, an optical-fiber connector C is provided, which is adapted to be coupled to an optical-fiber adapter A for optical signals and electric power transmissions. The optical-fiber connector C is coupled to the vehicle-mounted camera to provide electric power for the vehicle-mounted camera and to transmit the image captured by the vehicle-mounted camera.

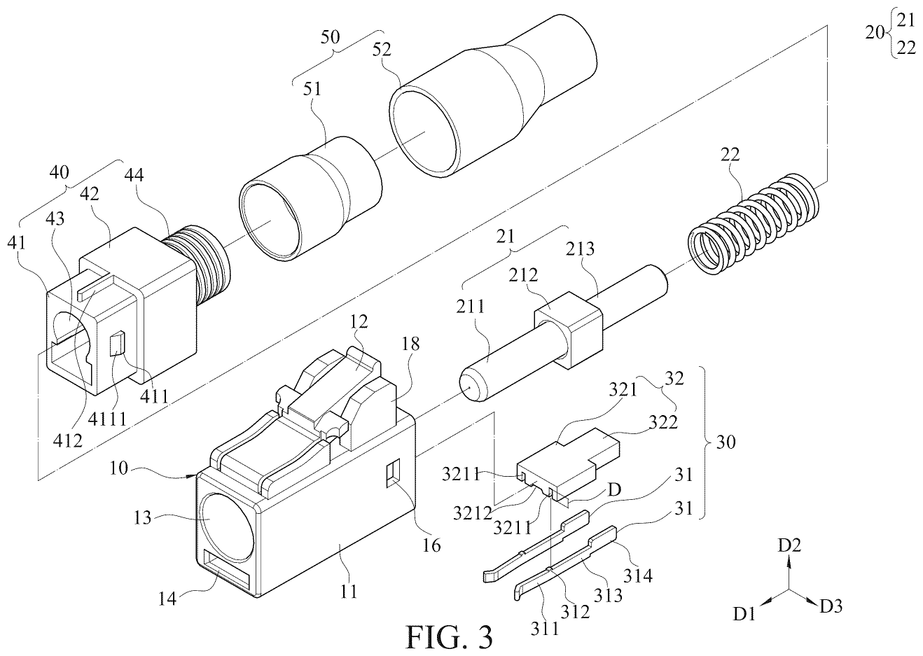

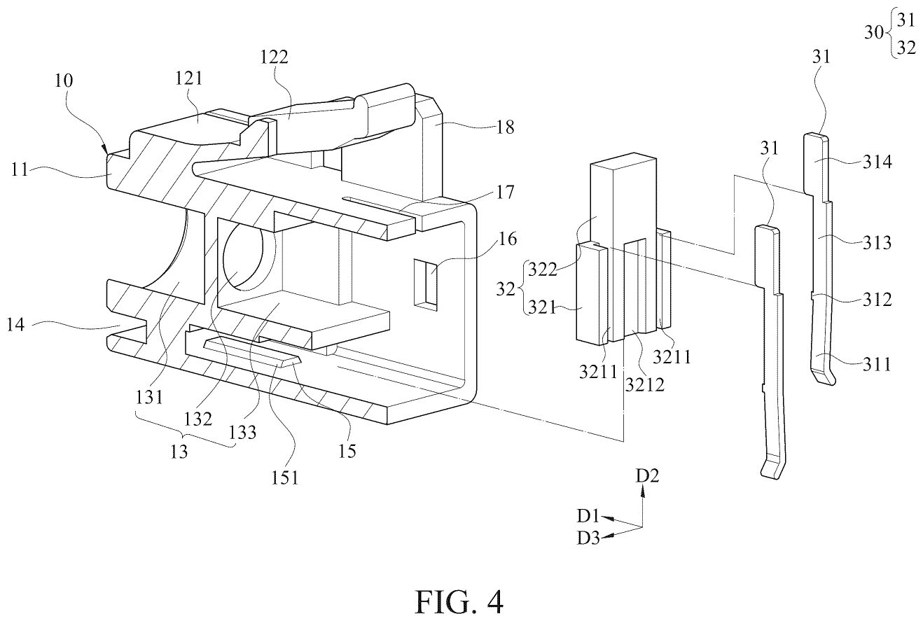

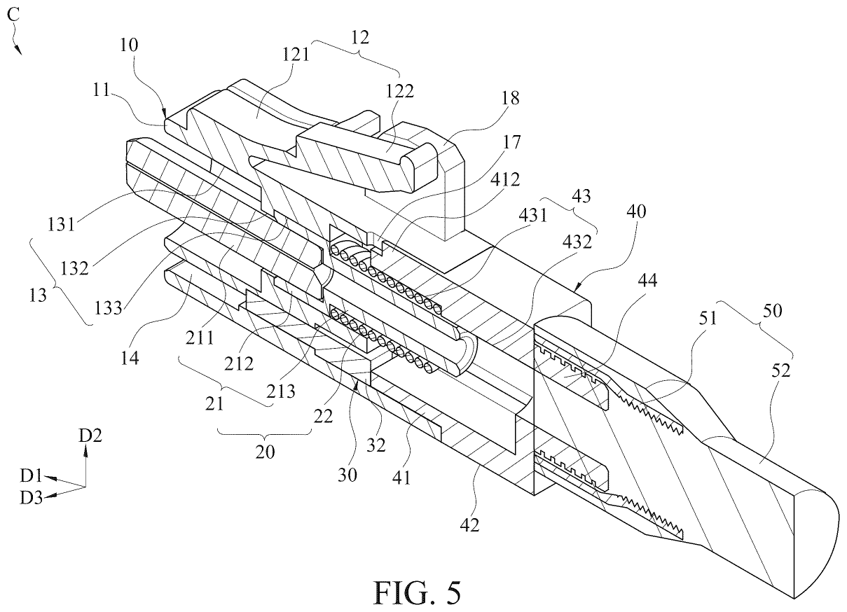

Please refer to FIG. 3 to FIG. 5. FIG. 3 illustrates an exploded view of the optical-fiber connector of the exemplary embodiment. FIG. 4 illustrates an exploded partial view of the optical-fiber connector of the exemplary embodiment. FIG. 5 illustrates a perspective cross-sectional view along line 5-5 shown in FIG. 1. In this embodiment, the optical-fiber connector C comprises a first housing 10, a core component 20, a conductive module 30, a second housing 40, and a sleeve member 50. The first housing 10 is a rectangular structure and comprises a stopping member 12, a through hole 13, and a channel 14. The stopping member 12 is on an outer surface 11 at one of two sides of the first housing 10, the through hole 13 and the channel 14 are respectively defined through two ends of the first housing 10, and the channel 14 is at one side of the through hole 13 and corresponds to the other side of the first housing 10; in other words, in this embodiment, the channel 14 is adjacent to the other side of the first housing 10. The core component 20 is elastically displaceably inserted into the through hole 13 of the first housing 10 along a first direction D1. The conductive module 30 comprises two conductive terminals 31 inserted into the channel 14 of the first housing 10. The second housing 40 is assembled at the through hole 13 at one end of the first housing 10. The sleeve member 50 is assembled on the second housing 40. Accordingly, one or some embodiments can provide an optical-fiber connector C capable of supplying electric power and transmitting optical signals at the same time.

Please refer to FIG. 1 to FIG. 5. The first housing 10 is mainly for carrying the core component 20 and the conductive module 30. In some embodiments, the first housing 10 is a hollow hexahedral structure with a rectangular cross-section. In these embodiments, the length of the first housing 10 extends along the first direction D1, and the outer surface 11 is formed by several planes, the through hole 13 and the channel 14 are defined through the two ends of the first housing 10 along the first direction D1, so that the core component 20 and the conductive module 30 are respectively arranged in the through hole 13 and the channel 14.

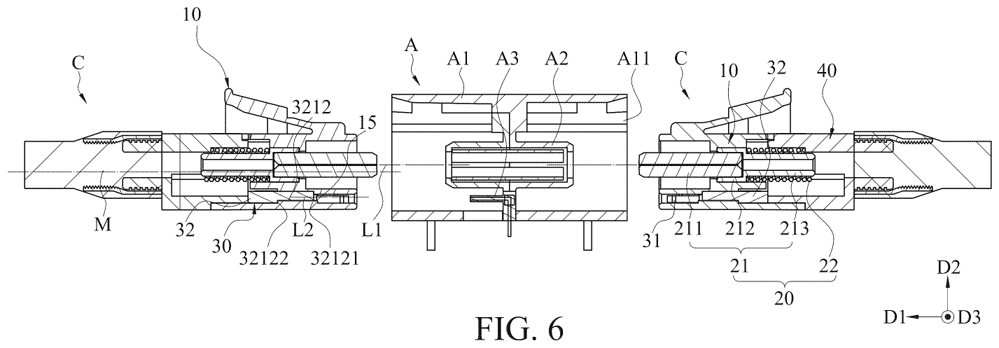

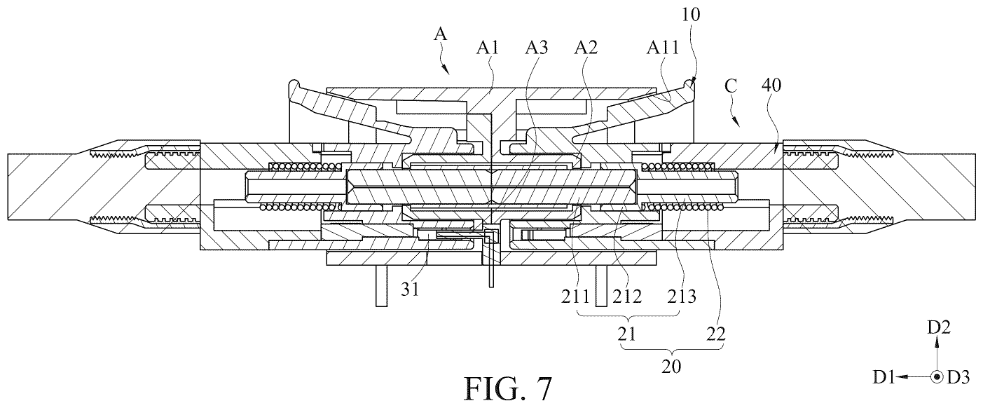

Please refer to FIG. 5 to FIG. 7. FIG. 6 illustrates a cross-sectional view of the embodiment shown in FIG. 2. FIG. 7 illustrates an assembled cross-sectional view showing the optical-fiber connector of the exemplary embodiment is coupled to the optical-fiber adapter. In some embodiments, two ends of the stopping member 12 are respectively a fixed end 121 and a free end 122. The fixed end 121 is fixed on the outer surface 11 of the first housing 10, and the free end 122 is away from the outer surface 11 of the first housing 10, so that the free end 122 can be moved flexibly relative to the fixed end 121 and the outer surface 11 of the first housing 10. In these embodiments, the first housing 10 can be engaged with the optical-fiber adapter A through the stopping member 12, and the engagement between the stopping member 12 and the optical-fiber adapter A can be released by pressing the free end 122, so that the optical-fiber connector C can be detached from the optical-fiber adapter A.

Please refer to FIG. 4 and FIG. 5. In some embodiments, the through hole 13 has a first section 131, a second section 132, and a third section 133 sequentially connected to each other, the first section 131 extends to one of two ends of the first housing 10, and the third section 133 extends to the other end of the first housing 10. In these embodiments, inner peripheral contours of the first section 131 and the second section 132 are circular, and an inner peripheral contour of the third section 133 is noncircular (as shown in FIG. 5, the inner peripheral contour of the third section 133 is rectangular). In the embodiment shown in FIG. 4, the inner peripheral contour of the third section 133 is rectangular, but the instant disclosure is not limited thereto. In these embodiments, a diameter of the inner peripheral contour of the first section 131 is greater than a diameter of the inner peripheral contour of the second section 132, and the diameter of the inner peripheral contour of the second section 132 correspond to a portion of the core component 20, so that the portion of the core component 20 can pass through the second section 132 and be inserted into the first section 131, and thus the portion of the core component can be limited at the joint portion between the first section 131 and the second section 132 to be moved unidirectionally.

Please refer to FIG. 4 to FIG. 6. An inner peripheral contour of the channel 14 is formed by several planes (that is, the inner peripheral contour is not circular). Viewing from the first direction D1, the first channel 14 is an elongated rectangular slot adapted to limit a conductive port A3 of the optical-fiber adapter A. In some embodiments, a second direction D2 is perpendicular to the first direction D1, and a central position of the first housing 10 along the second direction D2 has a central axis M. In this embodiment, the second direction D2 is perpendicular to the outer surface 11 connected to the fixed end 121 of the stopping member 12. In these embodiments, a central position of the through hole 13 has a first centerline L1 along the second direction D2, a central position of the channel 14 has a second centerline L2 along the second direction D2, and the first centerline L1 and the second centerline L2 are respectively at two sides of the central axis M. That is, in this embodiment, the through hole 13 and the channel 14 are respectively at different positions of the first housing 10 along the second direction D2.

Please refer to FIG. 3. In some embodiments, the core component 20 comprises a core member 21 and an elastic member 22. In some embodiments, the core member 21 comprises an insertion pin 211, a blocking member 212, and a connection sleeve 213. The blocking member 212 is a rectangular structure, the insertion pin 211 and the connection sleeve 213 are cylindrical structures, and a cross-sectional area of the insertion pin 211 and a cross-sectional area of the connection sleeve 213 are each less than a cross-sectional area of the blocking member 212. In some embodiments, the insertion pin 211 is formed of ceramic, and a center of the insertion pin 211 has a tiny hole for positioning with optical fibers.

Please refer to FIG. 3 to FIG. 5. In these embodiments, the size and the shape of the second section 132 of the through hole 13 of the first housing 10 correspond to the size and the shape of the insertion pin 211 of the core member 21 of the core component 20, and the size and the shape of the third section 133 correspond to the size and the shape of the blocking member 212 of the core member 21. In this embodiment, the insertion pin 211 of the core member 21 is inserted into the first section 131 through the second section 132 of the through hole 13, the blocking member 212 and the connection sleeve 213 are in the third section 133, the blocking member 212 abuts against the joint portion between the first section 131 and the second section 132, and the elastic member 22 is fitted over the connection sleeve 213.

Please refer to FIG. 3 to FIG. 5. In some embodiments, the optical-fiber connector C further comprises a fitting member 32, and the two conductive terminals 31 as well as the fitting member 32 are retained in the channel 14. In these embodiments, one face of the fitting member 32 has two first fitting grooves 3211, each of the conductive terminals 31 is retained in a corresponding one of the first fitting grooves 3211, and the fitting member 32 is retained in the channel 14. Accordingly, the conductive terminals 31 can be stably retained in the channel 14.

Please refer to FIG. 3 to FIG. 5. In some embodiments, the fitting member 32 is a block structure and comprises a first portion 321 and a second portion 322 connected to each other. The first portion 321 and the second portion 322 are elongated rectangular structures. In these embodiments, a direction perpendicular to the first direction D1 and the second direction D2 is defined as a third direction D3, the second portion 322 is connected to one side of the first portion 321 along the first direction D1, a thickness of the first portion 321 along the second direction D2 is equal to a thickness of the second portion 322 along the second direction D2, and a width of the first portion 321 along the third direction D3 is greater than a width of the second portion 322 along the third direction D3. Therefore, the fitting member 32 is approximately formed as a T-shaped structure. In these embodiments, each of the first fitting grooves 3211 is arranged on the face of the first portion 321 along the first direction D1, each of the first fitting grooves 3211 is defined through two sides of the first portion 321 along the first direction D1, and each of the first fitting grooves 3211 is at two sides of the second portion 322 along the third direction D3. In this embodiment, a length of each of the conductive terminals 31 is less than a length of the corresponding one of the first fitting grooves 3211 along the first direction D1, and the fitting member 32 is fitted over one side of each of the conductive terminals 31 through the corresponding one of the first fitting grooves 3211. When the conductive terminals 31 as well as the fitting member 32 are retained in the channel 14, along the second direction D2, two opposite sides of each of the conductive terminals 31 respectively abut against the corresponding one of the first fitting grooves 3211 of the fitting member 32 and the first housing 10. Accordingly, the conductive terminals 31 can be limited in the channel 14 of the housing 10.

Please refer to FIG. 3 to FIG. 5. Each of the conductive terminals 31 is an elongated plate structure in which the length thereof extends along the first direction D1. Each of the conductive terminals 31 comprises a first pin portion 311, a stopping portion 312, an extension section 313, and a second pin portion 314 sequentially connected to each other. Each of the first fitting grooves 3211 has a depth D along the second direction D2, and a height of the stopping portion 312 along the second direction D2 and a height of the second pin portion 314 along the second direction D2 are each greater than the depth D. In these embodiments, a height of the extension section 313 along the second direction D2 is less than or equal to the depth D of the first fitting groove 3211. Accordingly, when each of the conductive terminals 31 is accommodated in the corresponding one of the first fitting grooves 3211 of the fitting member 32, the extension section 313 of the conductive terminal 31 is accommodated in the first fitting groove 3211, while the stopping portion 312 and the second pin portion 314 are blocked outside the first fitting groove 3211. Therefore, the movement of the conductive terminal 31 relative to the fitting member 32 along the first direction D1 can be limited.

Please refer to FIG. 3 to FIG. 5. In some embodiments, the first housing 10 further comprises a protrusion 15 in the channel 14. In these embodiments, the face of the fitting member 32 provided with the first fitting grooves 3211 further has a second fitting groove 3212, the second fitting groove 3212 is between the two first fitting grooves 3211, and two ends of the second fitting groove 3212 are respectively an opening 32121 and a stopping surface 32122. The fitting member 32 is fitted over the protrusion 15 through the second fitting groove 3212, and the stopping surface 32122 abuts against the protrusion 15 to limit the movement of the fitting member 32.

Please refer to FIG. 3 to FIG. 5. In some embodiments, when the fitting member 32 is fitted over the protrusion 15 through the second fitting groove 3212, along the first direction D1, the opening 32121 of the second fitting groove 3212 of the fitting member 32 is farther from the third section 133 of the through hole 13 of the first housing 10, as compared with the stopping surface 32122 of the second fitting groove 3212 (that is, in some embodiments, a distance between the opening 32121 and the third section 133 is greater than a distance between the stopping surface 32122 and the third section 133). Accordingly, along the first direction D1, the protrusion 15 can limit the fitting member 32 from being moved toward one end of the first housing 10 having the first section 131.

Please refer to FIG. 3 to FIG. 5. In some embodiments, the protrusion 15 of the first housing 10 has two inclined surfaces 151, and the two inclined surfaces 151 are symmetrically arranged on different positions of the protrusion 15 along the second direction D2. In these embodiments, the shape of the second fitting groove 3212 of the fitting member 32 corresponds to the shape of the protrusion 15. Accordingly, through the configuration of the second fitting groove 3212 of the fitting member 32 and the inclined surfaces 151 of the protrusion 15, the fitting member 32 can be fitted over the protrusion 15 smoothly and conveniently.

Please refer to FIG. 3 to FIG. 5. In some embodiments, the second housing 40 has a first body 41 and a second body 42 connected to each other. An outer contour of the first body 41 corresponds to the inner contour of the third section 133 of the first housing 10, and an outer contour of the second body 42 corresponds to an outer contour of the first housing 10. In these embodiments, the second housing 40 is inserted into the third section 133 of the through hole 13 of the first housing 10 with the first body 41, and the outer surface of the second body 42 is flush with the outer surface 11 of the first housing 10. Accordingly, the second housing 40 can be assembled on the first housing 10, and the assembled component has a uniform appearance.

Please to FIG. 3 to FIG. 5. In some embodiments, the second housing 40 further comprises a penetration hole 43 defined through the first body 41 and the second body 42 along the first direction D1, and the penetration hole 43 has a first half 431 and a second half 432 connected to each other. The first half 431 is in the first body 41, the second half 432 is in the second body 42, and the first half 431 is in communication with the second half 432. In these embodiments, an inner diameter of the first half 431 is greater than an inner diameter of the second half 432. Specifically, in these embodiments, the inner diameter of the first half 431 is substantially equal to an outer diameter of the elastic member 22, and the inner diameter of the second half 432 is substantially equal to an outer diameter of the connection sleeve 213 of the core member 21. Accordingly, when the second housing 40 is inserted into the first housing 10 with the first body 41, the other end of the elastic member 22 is inserted into the first half 431 in the first body 41 of the second housing 40, and the other end of the elastic member 22 thus can abut against a joint surface between the first half 431 and the second half 432 to be ready to store elastic force. Hence, when the core member 21 of the core component 20 is applied with a force, the core member 21 can compress the elastic member 22 to store the elastic force. Therefore, the core component 20 can perform elastically displacement. Accordingly, when the optical-fiber connector C is mated with the optical-fiber adapter A through the core component 20, the core component 20 can provide a slight cushioning function to prevent the core component 20 to be damaged or broken during the assembling process.

Please refer to FIG. 3 to FIG. 5. In some embodiments, the first housing 10 further comprises a first assembling portion 16, and the second housing 40 further comprises a second assembling portion 411. The position of the first assembling portion 16 corresponds to the position of the third section 133 of the through hole 13, and the second assembling portion 411 is at the first body 41 of second housing 40. In these embodiments, when the second housing is assembled on the first housing 10 with the first body 41, the second assembling portion 411 is assembled on and positioned with the first assembling portion 16.

Please refer to FIG. 3 to FIG. 5. In the embodiments where the first housing 10 comprises the first assembling portion 16 and the second housing 40 comprises the second assembling portion 411, the structures of the first assembling portion 16 and the second assembling portion 411 may be but not limited to concave and convex structures. In some embodiments, the first assembling portion 16 is a hole defined through the outer surface 11 and the second assembling portion 411 is a protruding block capable of being accommodated in the hole. In the embodiment where the second assembling portion 411 is a protruding block, the second assembling portion 411 further has a guiding surface 4111 inclined relative to the outer surface of the first body 41. In one embodiment, the guiding surface 4111 has a changing slope, and an angle between the guiding surface 4111 and the outer surface of the first body 41 increases toward the second body 42. Therefore, when the first body 41 is assembled on the first assembling portion 16 of the first housing 10 with the second assembling portion 411, the guiding surface 4111 of the second assembling portion 411 can provide the guiding function. Hence, firstly the second assembling portion 411 contacts the first assembling portion 16 with a portion of the guiding surface 4111 having a smaller angle, then through the guiding of the guiding surface 4111, the second assembling portion 411 contacts the first assembling portion 16 with a portion having a larger angle. Accordingly, the assembling difficulty of the first assembling portion 16 and the second assembling portion 411 can be reduced, and the assembling process can be conducted conveniently.

It is understood that, the structures of the first assembling portion 16 and the second assembling portion 411 are not limited to the foregoing embodiments; in some other embodiments, the first assembling portion 16 may be a protruding block while the second assembling portion 411 may be a hole, and the same object and function can also be achieved in these embodiments.

Please refer to FIG. 3 to FIG. 5. In some embodiments, the first housing 10 further has a cut opening 17, and the second housing 40 further comprises a protruding rib 412. The cut opening 17 is defined through the outer surface 11, and the protruding rib 412 is on the first body 41 and capable of being accommodated into the cut opening 17. In these embodiments, the cut opening 17 is an elongated slot defined along the first direction D1, and the protruding rib 412 is an elongated plate extending along the first direction D1.

Please refer to FIG. 3 to FIG. 5. In some embodiments, the first assembling portions 16 of the first housing 10 are arranged on the two opposite planes of the outer surface 11 perpendicular to the third direction D3, and the cut opening 17 is arranged on the plane of the outer surface 11 perpendicular to the second direction D2. Therefore, the mating between the first assembling portion 16 and the second assembling portion 411 and the mating between the cut opening 17 and the protruding rib 412 respectively limit movements of the first housing 10 and the second housing 40 along different directions. Hence, after the first housing 10 is assembled with the second housing 40, the assembled structure can possess a proper structural stability.

Please refer to FIG. 3 to FIG. 5. In some embodiments, the first housing 10 further comprises two blocking walls 18 opposite to each other. The blocking walls 18 are arranged on the outer surface 11 and respectively at two sides of the stopping member 12. In these embodiments, the blocking walls 18 are arranged on the outer surface 11 fixedly. Accordingly, after the optical-fiber connector C is mated with the optical-fiber adapter A, such configuration prevents the stopping member 12 from being accidentally touched, which would unlock the optical-fiber adapter A and cause the optical-fiber connector C and the optical-fiber adapter A to separate from each other. Hence, such configuration improves operational stability.

Please refer to FIG. 3 to FIG. 5. The sleeve member 50 is adapted to enclose and thus protect the connection wires. In some embodiments, the sleeve member 50 comprises a first sleeve 51 and a second sleeve 52. In these embodiments, the second housing 40 further comprises a connection portion 44 extending from the second body 42 along the first direction D1, and the first sleeve 51 is detachably coupled to the connection portion 44 of the second housing 40. In some embodiments, the connection portion 44 of the second housing 40 is a hollow cylindrical structure with outer threaded patterns, while the first sleeve 51 is a hollow cylindrical structure with inner threaded patterns, but the instant disclosure is not limited thereto.

In some other embodiments, the connection portion 44 of the second housing 40 may be a hollow cylindrical structure with inner threaded patterns, while the first sleeve 51 may be a hollow cylindrical structure with outer threaded patterns.

Please refer to FIG. 3 to FIG. 5. In some embodiments, the first sleeve 51 may be formed of a material without flexibility, while the second sleeve 52 may be a heat-shrunken tube with flexibility. Therefore, the first sleeve 51 prevents the connection wires in the optical-fiber connector C from being pressed and damaged, while the second sleeve 52 provides the protection function and allows the wires to be bent to some extents.

Please refer to FIG. 2. In some embodiments, the optical-fiber adapter A comprises an adapter body A1, two sockets A2, and a conductive port A3. The adapter body A1 has two insertion openings A11 respectively at two opposite ends of the adapter body A1. The two sockets A2 are oppositely arranged in the adapter body A1, and the conductive port A3 is arranged in the adapter body A1. In these embodiments, when the optical-fiber connector C is coupled to the optical-fiber adapter A, each of the insertion openings A11 of the optical-fiber adapter A can be connected to a corresponding optical-fiber connector C, and the first housing 10 of the optical-fiber connector C is inserted into the insertion opening A11. After the optical-fiber connector C is inserted into the insertion opening A11 with the first housing 10, the insertion pin 211 of the core member 21 of the core component 20 of the optical-fiber connector C can be correspondingly inserted into the socket A2, and the conductive terminal 31 can correspondingly contact the conductive port A3. Accordingly, the optical signals and electric power transmission can be achieved at the same time.

What is claimed is:

1. An optical-fiber connector, comprising:
a first housing comprising a stopping member, a through hole, and a channel, wherein the stopping member is on an outer surface of one of two sides of the first housing, the through hole and the channel are respectively defined through two ends of the first housing, and the channel is at one side of the through hole and corresponds to the other side of the first housing;
a core component elastically displaceably inserted into the through hole of the first housing along a first direction;
a conductive module comprising two conductive terminals inserted into the channel of the first housing;
a second housing assembled at the through hole at one end of the first housing; and
a sleeve member assembled on the second housing.

2. The optical-fiber connector according to claim 1, wherein the first housing further comprises two blocking walls opposite to each other and arranged on the outer surface of the first housing, and the two blocking walls are respectively at two sides of the stopping member.

3. The optical-fiber connector according to claim 1, wherein the first housing further has a cut opening defined through the outer surface of the first housing, the second housing further comprises a protruding rib, and the protruding rib of the second housing is accommodated in the cut opening.

4. The optical-fiber connector according to claim 1, wherein a length of the first housing extends along the first direction, a second direction is perpendicular to the first direction, a central position of the first housing along the second direction has a central axis, a central position of the through hole has a first centerline along the second direction, a central position of the channel has a second centerline along the second direction, and the first centerline and the second centerline are respectively at two sides of the central axis.

5. The optical-fiber connector according to claim 1, wherein the core component comprises a core member and an elastic member, the elastic member is fitted over the core member, the core member abuts against the first housing, and the second housing abuts against the elastic member.

6. The optical-fiber connector according to claim 5, wherein the core member comprises an insertion pin, a blocking member, and a connection sleeve; the insertion pin and the connection sleeve are respectively at two opposite sides of the blocking member, and the elastic member is fitted over the connection sleeve; the through hole has a first section, a second section, and a third section sequentially connected to each other, the blocking member, the connection sleeve, and the elastic member are in the third section, and the insertion pin is in the first section and the second section.

7. The optical-fiber connector according to claim 6, wherein a cross-section of the blocking member and a cross-section of the third section are rectangular.

8. The optical-fiber connector according to claim 1, wherein the conductive module comprises a fitting member, one face of the fitting member has two first fitting grooves, each of the two conductive terminals is retained in a corresponding one of the two first fitting grooves, and the fitting member is retained in the channel.

9. The optical-fiber connector according to claim 8, wherein a length of the fitting member and a length of the conductive terminals extend along the first direction; each of the conductive terminals comprises a first pin portion, a stopping portion, an extension section, and a second pin portion sequentially connected to each other; each of the first fitting grooves is defined through the fitting member along the first direction, each of the first fitting grooves has a depth along a second direction perpendicular to the first direction, and a height of the stopping portion along the second direction and a height of the second pin portion along the second direction are each greater than the depth.

10. The optical-fiber connector according to claim 8, wherein the first housing further comprises a protrusion in the channel; the face of the fitting member has a second fitting groove between the two first fitting grooves, and two ends of the second fitting groove are respectively an opening and a stopping surface; the fitting member is fitted over the protrusion through the second fitting groove, and the stopping surface abuts against the protrusion.

11. The optical-fiber connector according to claim 10, wherein the protrusion has two inclined surfaces, and the two inclined surfaces are symmetrically arranged on different positions of the protrusion along the second direction.
